(19) United States
(12) Patent Application Publication
(10) Pub. No.: US 2007/0164841 A1
(43) Pub. Date: Jul. 19, 2007

(54) High-frequency filter

(75) Inventors: Yu-Ru Juang, Taoyuan Hsien (TW); Ching-Lai Ke, Taoyuan Hsien (TW)

Correspondence Address: BACON & THOMAS, PLLC, 625 SLATERS LANE, FOURTH FLOOR, ALEXANDRIA, VA, 22314, US

(73) Assignee: PRIME ELECTRONICS AND SATELLITICS INCORPORATION, TAOYUAN HSIEN (TW)

(21) Appl. No.: 11/511,290

(22) Filed: Aug. 29, 2006

(30) Foreign Application Priority Data
Jan. 18, 2006 (TW) 95201146

(51) Int. Cl. H01P 1/203

(52) U.S. Cl. 333/205

(57) ABSTRACT

A high-frequency filter for providing an analog signal with a predetermined bandwidth includes a printed circuit on which a tuner is covered. The printed circuit includes a signal circuit having a plurality of resonators magnetically or electrically coupled with each other, and a grounding circuit electrically connected to ground and arranged around the resonators. The tuner includes a shell made of a conductive metal, electrically connected to the grounding circuit and covered over the resonators such that an isolation chamber is defined between the shell and the resonators, and an adjustment member movably mounted in the shell and moveable relative to the resonators to adjust the dimension of the isolation chamber so as to further adjust a range of the bandwidth of the analog signal.

### BACKGROUND OF THE INVENTION

1. Field of the Invention

The present invention relates to a radio frequency circuit for wireless communication and more particularly, to a filter utilizing a printed circuit technology.

2. Description of the Related Art

Following fast development of wireless communication market, system demand for wide band communication keeps increasing. A bandpass filter with wide bandwidth is required for channel selection in transmitter and receiver of communication system. A high performance bandpass filter is the key point that determines system communication quality. A high performance bandpass filter has the characteristics of high selectivity and low insertion loss. The so-called selectivity here is the ability of discriminating between signals at different frequencies. A high selectivity filter effectively attenuates side band signals, shortens the guard band width between desired bands, and allows efficient use of the radio frequency. This is the key point to determine the quantity of the filter's Q factor. The so-called insertion loss means the decade of signal attenuation. A low insertion loss filter obtains a relatively higher receiving gain.

FIG. 1 is a block diagram of a down-conversion circuit 1 of an LNB (Low Noise Block) Down Converter. As shown in the FIG. 1, the down-conversion circuit 1 uses an antenna 11 to receive a satellite signal. After receipt of the satellite signal, the satellite signal is amplified in proper order through three LNAs (Low Noise Amplifiers) 12, thereby providing a RF signal. This three-step signal amplification prevents feedback oscillation of the high frequency EM (electromagnetic) wave occurred by the only one-step amplification with excessively amplifying power. The RF signal is then processed through an image rejection filter 13 to reject image channel, and then mixed with a lower oscillation frequency provided by an LO (Local Oscillator) 14 into a mixer 15 to form an IF (Intermediate Frequency) signal for further demodulation processing by posterior circuits. The image channel to be rejected by the image rejection filter 13 occurs at twice the IF from the desired RF channel frequency. The image rejection capability of the image rejection filter 13 has a great concern with its selectivity, determining the quality of the posterior demodulated IF or baseband signal. An excessive intensity of image signal degrades the quality of wanted signal, and may result in a signal receiving error at the user end.

Regularly, the measure to improve the selectivity is to increase the order of the filter. However, this measure requires an additional component parts installation space and may sacrifice bandwidth and gain of pass band, lowering broadband performance. More particularly, in a modern microwave communication system, C-band and Ku-band are insufficient to meet the demand thus the higher Ka-band is provided. The design of increasing the order of the filter under the condition of rising the radio frequency and local oscillating frequency and increasing the bandwidth without changing the intermediate frequency is insufficient to deal with the demand. Newly developed microstrip filters based on the printed circuit technology, such as inter-digital filters, edge coupled micro-strip filters and hairpin filters, show superior to conventional designs in circuit space saving, selectivity and insertion loss. However, the transmission lines that are arranged together in a high density manner tend to be affected by PCB (Printed Circuit Board) manufacturing defects, such as miss-alignment of photo mask or etching error of conducting lines. When these manufacturing problems mentioned above do exist, either need a re-simulation design that will waste much manufacturing time and increase manufacturing cost, or may cause a minor shift of the resonance frequency of the filter, thereby lowering product yield. These situations result in the problem of signal quality deterioration or signal receiving error at the user end.

### SUMMARY OF THE INVENTION

The present invention has been accomplished under the circumstances in view. It is the main object of the present invention to provide a high-frequency filter, which has high selectivity and low insertion loss, improves wireless communication signal receiving quality, increases product yield, and lowers manufacturing cost.

To achieve this object of the present invention, the high-frequency filter for providing an analog signal with a predetermined bandwidth comprises a printed circuit board having a printed circuit thereon, and a turner. The printed circuit includes a signal circuit having a plurality of resonators magnetically or electrically coupled with each other, an input terminal and an output terminal, and a grounding circuit electrically connected to ground and arranged around the resonators. The resonators comprise a first resonator electrically connected to the input terminal and a second resonator electrically connected to the output terminal. The tuner includes a shell made of a conductive metal, electrically connected to the grounding circuit and covered over the resonators such that an isolation chamber is defined between the shell and the resonators, and an adjustment member movably mounted in the shell and moveable relative to the resonators to adjust the dimension of the isolation chamber so as to further adjust a range of the bandwidth of the analog signal.

### BRIEF DESCRIPTION OF THE DRAWINGS

FIG. 1 is a block diagram of a down-conversion circuit of an LNB (Low Noise Block) Down Converter according to the prior art.

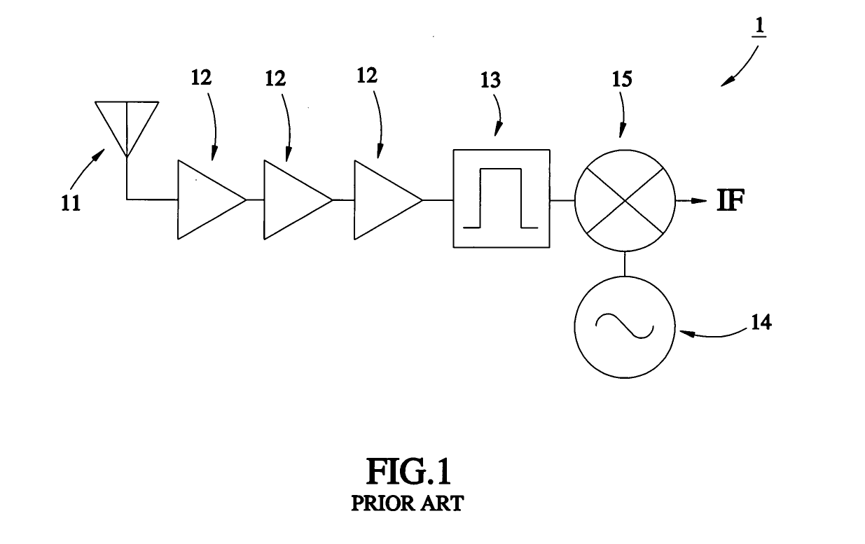

FIG. 2 is a schematic drawing showing the circuit layout of a printed circuit in accordance with a first embodiment of the present invention.

FIG. 3 is a perspective exploded view of a high-frequency filter in accordance with the first embodiment of the present invention.

FIG. 4 is a perspective exploded view of a high-frequency filter in accordance with a second embodiment of the present invention.

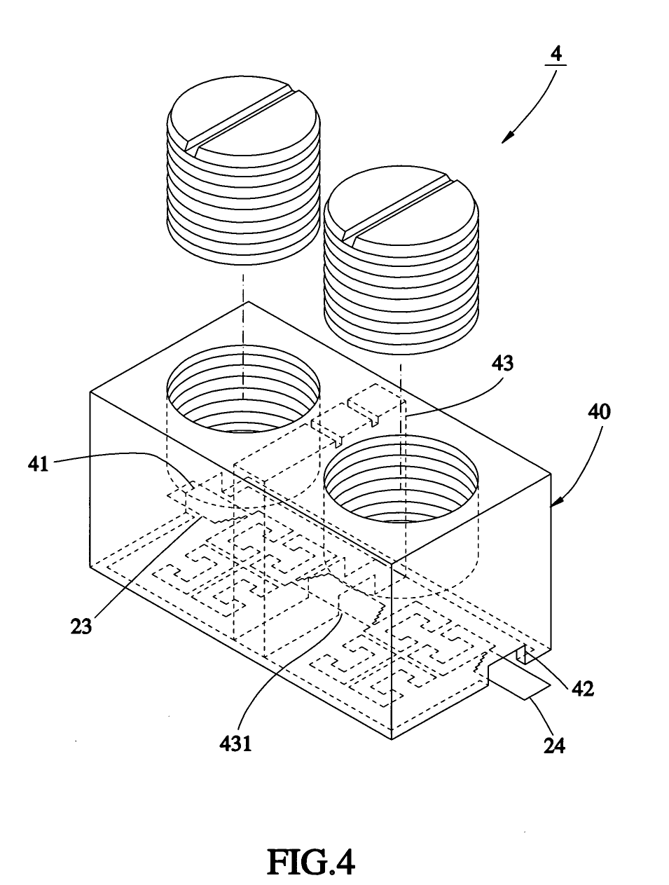

FIG. 5 is a frequency response characteristic chart obtained from the high-frequency filter of the second embodiment of the present invention.

### DETAILED DESCRIPTION OF THE INVENTION

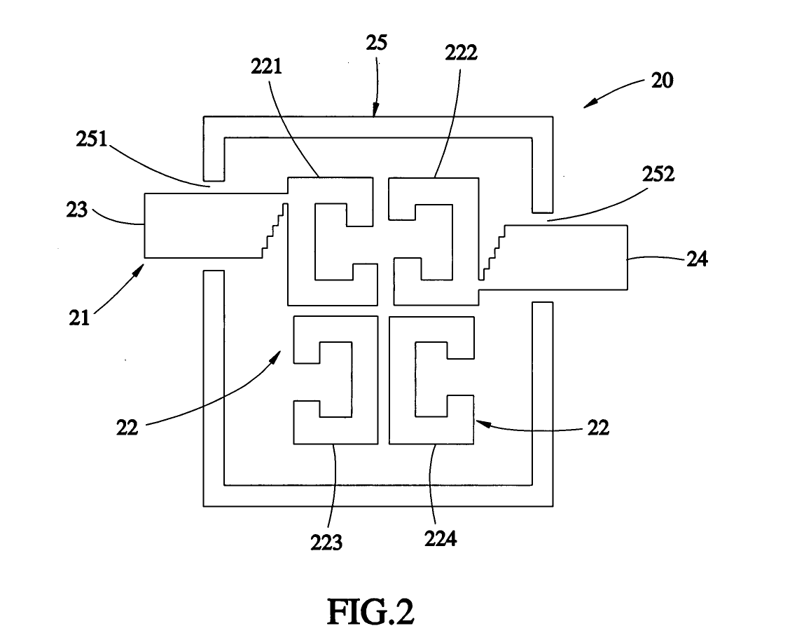

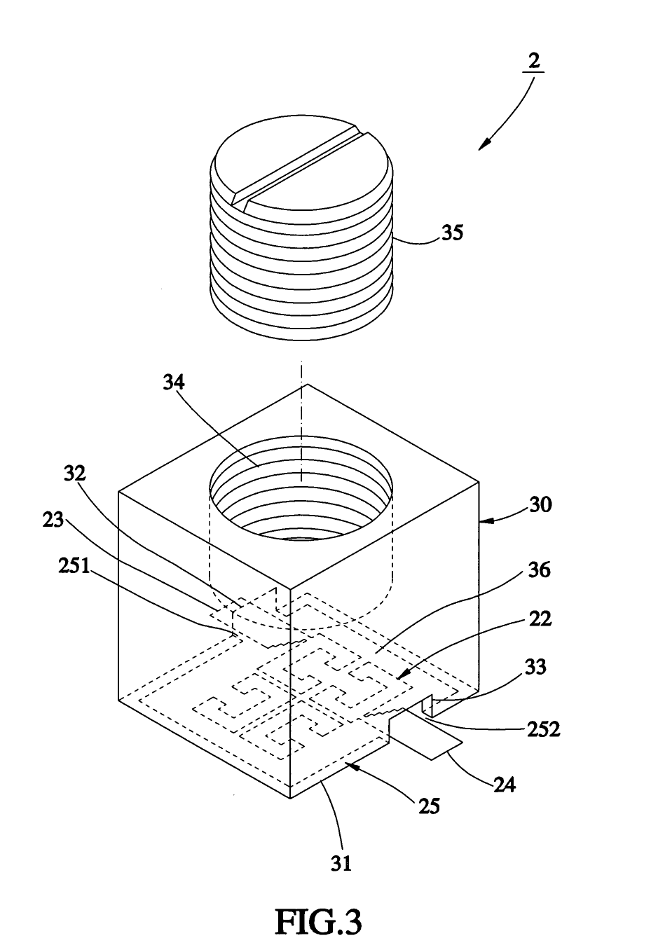

Referring to FIGS. 2 and 3, a high-frequency filter 2 in accordance with a first embodiment of the present invention can be utilized as an image rejection filter for LNB (Low Noise Block) Down Converter. The high-frequency filter 2 comprises a printed circuit 20 on a printed circuit board (not shown), and a tuner 30 at the top side of the printed circuit 20.

As shown in FIG. 2, the printed circuit 20 is a general type of the printed CQ (Cascade Quadruplet) filter, comprising a signal circuit 21 and a grounding circuit 25. The signal circuit 21 has four resonators 22, an input terminal 23, and an output terminal 24. The input terminal 23 and the output terminal 24 are for the input and output of RF (Radio Frequency) signal respectively. Each resonator 22 is a resonant cavity formed of a C-shaped half-wavelength transmission line. Further, the first resonator 221 and the second resonator 222 are magnetically coupled to each other and respectively connected to the input terminal 23 and the output terminal 24. The third resonator 223 and the fourth resonator 224 are electrically coupled to each other. The grounding circuit 25 is electrically connected to ground, forming an interrupted ground level around the resonators 22. The grounding circuit 25 has two openings 251 and 252 for the passing of the input terminal 23 and the output terminal 24 respectively. The pitch designed between the grounding circuit 25 and the resonators 22 determines specific conditions of bandwidth of the high-frequency filter 2.

Referring to FIG. 3, the tuner 30 includes a hollowed shell made of a conductive metal and covered on the resonators 22, thereby forming an electrical shielding for the high-frequency filter 2. The metal shell of the tuner 30 is electrically connected to the grounding circuit 25, having a bottom flange 31, two through holes 32 and 33 formed on the bottom side corresponding to the two openings 251 and 252 of the grounding circuit 25, an adjustment hole 34 on the top side, which receives an adjustment member 35, and an isolation chamber 36. The bottom flange 31 and the grounding circuit 25 have the same profile. The input terminal 23 and the output terminal 24 extend respectively through the holes 32 and 33 without electrically contact with the bottom flange 31. The adjustment member 35 matches the adjustment hole 34. According to this embodiment, the adjustment hole 34 is a screw hole, and the adjustment member 35 is an adjustment screw. The isolation chamber 36 is a specific accommodation chamber formed between the tuner 30 and the resonators 22. Changing the position of the adjustment member 35 relative to the resonators 22 changes the dimension of the isolation chamber 36.

The high-frequency filter 2 is constructed with a simple pattern of transmission line of the printed CQ filter. By means of the arrangement of the grounding circuit 25 and the electrical shielding shell of the tuner 30 and the adjustable isolation chamber 36, the equivalent capacity of the resonators 22 and the field inside the shell of the high-frequency filter 2 are adjustable so as to increase the electromagnetic coupling between the input terminal 23 and the output terminal 24, thereby providing an extra “zero” for the CQ filter. This zero removes nearby side bands and shortens the guard band width between adjacent radio bands to cause a steeper attenuation slope and to achieve a better Q factor. Therefore, the high-frequency filter of the present invention has a good capability of attenuating external frequencies, thereby enabling the RF signals to be used efficiently. More particularly, the high-frequency filter is suitable for image rejection. Because of the increasing of the electromagnetic coupling between the input terminal and the output terminal, the bandwidth of the high-frequency filter is relatively expanded. In general, while improving the capability of attenuating external frequencies, the present invention also expands the bandwidth for channel selection.

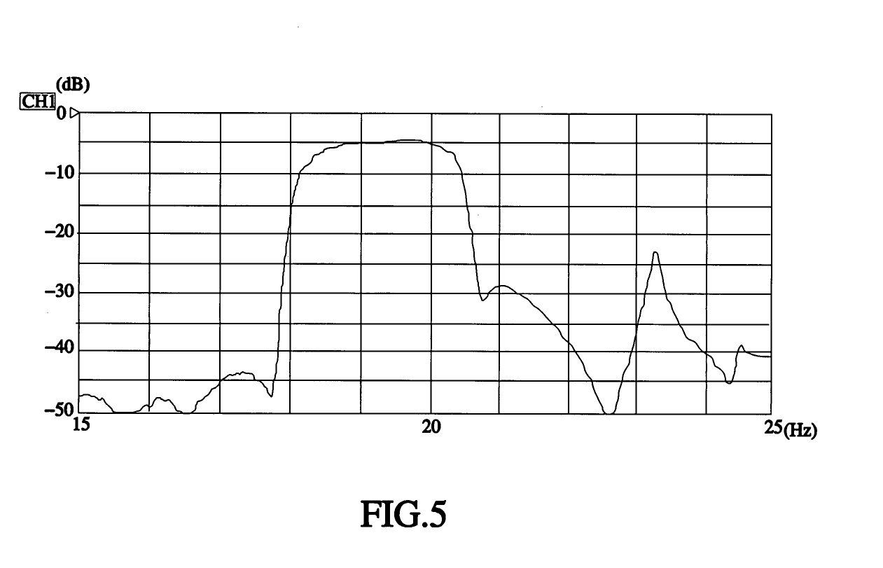

Further, since the present invention uses a simple structure to effectively adjust and improve the selectivity of the filter, a high-frequency filter of multi-order network can be achieved by simply cascading multiple high-frequency filters with same structure of the present invention. FIG. 2 shows a high-frequency filter 4 in accordance with a second embodiment of the present invention, which cascades two filters with the same structure provided in the previous embodiment. According to this embodiment, the metal shielding 40 is the combination of the metal shells of two joined tuners, having two bottom through holes 41 and 42 for the passing of the input terminal 23 and the output terminal 24 respectively, and a partition wall 43, which is equivalent to the abutted sidewalls of the metal shells of the two joined tuners and consequently formed a bottom through hole 431 for allowing electric connection of the two CQ filters. FIG. 5 shows the frequency response characteristic of the high-frequency filter 4. Under a specific operation frequency, the high-frequency filter 4 has a low insertion loss of the pass band, effectively removes side band frequencies and shortens the guard band width between adjacent radio bands, and causes an abrupt attenuation for image rejection. Therefore, the high-frequency filter 4 has a better capability of attenuating external frequencies and enables the radio frequencies to be utilized efficiently.

It is to be understood that the invention can be applicable to various printed circuit filters including the conventional microstrip filters. By means of arranging a grounding circuit subject to a predetermined circuit profile around the border area of the filter to match with a properly installed tuner structure, the present invention effectively improves the selectivity of the filter, eliminating the re-working problem due to PCB fabrication defects.

As stated above, the invention provides a high-frequency filter that allows adjustment of the volume of the isolation chamber to effectively remove side band frequencies and shorten the guard band width between adjacent radio bands, thereby causing an abrupt attenuation for image rejection and increasing the Q factor. Therefore, the high-frequency filter in accordance with the present invention has a high capability of attenuating external frequencies, allowing the radio frequencies to be utilized efficiently. When compared to the conventional printed microstrip filters without adjustment screw, the present invention has the following advantages:

1. The present invention eliminates the possibility of re-simulation of circuit design, saving much research and development time.

2. The present invention expands the bandwidth of the filter, providing an efficient filtering effect of high selectivity and low insertion loss.

3. The present invention is applicable to the conventional printed circuit filters.

4. The present invention eliminates the frequency shift due to PCB fabrication defects, improving the product yield.

Although the present invention has been explained in relation to its preferred embodiments, it is to be understood that many other possible modifications and variations can be made without departing from the spirit and scope of the invention as hereinafter claimed.

What is claimed is:

1. A filter for providing an analog signal with a predetermined bandwidth, the filter comprising:
a printed circuit board having a printed circuit thereon, the printed circuit including a signal circuit having a plurality of resonators magnetically or electrically coupled with each other, an input terminal and an output terminal, and a grounding circuit electrically connected to ground and arranged around the resonators; wherein the resonators comprises a first resonator electrically connected to the input terminal and a second resonator electrically connected to the output terminal;
a tuner including a shell made of a conductive metal, electrically connected to the grounding circuit and covered over the resonators such that an isolation chamber is defined between the shell and the resonators, and an adjustment member movably mounted in the shell and moveable relative to the resonators to adjust the dimension of the isolation chamber so as to further adjust a range of the bandwidth of the analog signal.

2. The filter as claimed in claim 1, wherein said signal circuit is a cascade quadruplet filter circuit having four C-shaped transmission lines.

3. The filter as claimed in claim 2, wherein each of the resonators has a half-wavelength transmission line.

4. The filter as claimed in claim 2, wherein the first resonator and the second resonator are magnetically coupled with each other.

5. The filter as claimed in claim 4, wherein the resonators comprise a third resonator and a fourth resonator, which are electrically coupled with each other.

6. The filter as claimed in claim 1, wherein the grounding circuit has two openings through which the input terminal and the output terminal respectively extend.

7. The filter as claimed in claim 6, wherein the shell of the tuner has two through holes respectively facing the openings of the grounding circuit.

8. The filter as claimed in claim 1, wherein the shell of the tuner has an adjustment hole in communication with the isolation chamber, and the adjustment member is movably inserted in the adjustment hole.

9. The filter as claimed in claim 8, wherein the adjustment hole of the shell of the tuner is a screw hole, and the adjustment member is a screw threaded into the screw hole.

10. The filter as claimed in claim 1, wherein an electromagnetic coupling between the input terminal and the output terminal can be increased by means of changing the dimension of the isolation chamber to produce an extra zero.

11. The filter as claimed in claim 10, which is an image rejection filter.

12. The filter as claimed in claim 1, which comprises two said signal circuits and two said tuners; wherein an output terminal of one said signal circuit is electrically connected to an input terminal of the other signal circuit.

13. The filter as claimed in claim 1, wherein said signal circuit is a printed microstrip transmission line.
